(19) United States
(12) Patent Application Publication
(10) Pub. No.: US 2026/0233288 A1
(43) Pub. Date: Aug. 13, 2026

(54) Pressing Tool

(71) Applicant: Novopress GmbH Pressen und Presswerkzeuge & Co. KG, Neuss (DE)

(72) Inventors: Stephan Krämer, Oberhausen (DE); Martin Bungter, Mönchengladbach (DE)

(21) Appl. No.: 19/571,635

(22) Filed: Mar. 19, 2026

Related U.S. Application Data
(62) Division of application No. 18/279,559, filed on Feb. 7, 2022.

(30) Foreign Application Priority Data
Mar. 4, 2021 (DE) 102021105243.2

(51) Int. Cl. B21D 39/04

(52) U.S. Cl. CPC B21D 39/048

(57) ABSTRACT

A pressing tool includes two pressing jaws which are movable towards one another from an open position into a closed position for pressing, said pressing jaws including a connecting element for connection to respective receiving elements of the pressing ring, so that the press ring is movable from an open position into a closed position by the movement of the pressing jaws for pressing the press fitting. The minimum spacing of the connecting elements in the open position is greater than the maximum spacing of the receiving elements of the press ring in the open position, and the minimum spacing of the connecting elements in the closed position corresponds to a minimum spacing of the receiving elements of the press ring in the closed position. Furthermore, the minimum spacing of the connecting elements in the open position is smaller than the maximum spacing of the receiving elements of a second press ring in the open position.

### CROSS-REFERENCE TO RELATED APPLICATIONS

This application is a divisional of U.S. patent application Ser. No. 18/279,559 filed Feb. 7, 2022, which is the United States national phase of International Application No. PCT/EP2022/052862 filed Feb. 7, 2022, and claims priority to German Patent Application No. 10 2021 105 243.2 filed Mar. 4, 2021, the disclosures of which are hereby incorporated by reference in their entireties.

### BACKGROUND OF THE INVENTION

### Field of the Invention

The present invention relates to a pressing tool for pressing a press fitting by means of a press ring, to such a press ring, and to a set comprising such a pressing tool and such a press ring.

### Description of Related Art

When pressing press fittings, in particular for the connection of tubular components by means of cold forming, it is known, for example, from EP 1 201 371, to use a press ring. The press ring has at least two segments which are connected to each other in a hinge-like manner. The press ring is connected to a pressing device by means of a pressing tool, whereby a mechanical pressing force can be applied by the pressing device to the press ring for pressing the press fitting. In particular, this is an electrohydraulic pressing device by which pressing jaws of the pressing tool are moved towards each other, the movement of the pressing jaws being transmitted to the press ring to close the press ring, as a result of which a reduction of an inner radius of the press ring occurs, by which the press fitting abutting the inner radius of the press ring is pressed.

There are different press ring for different press fittings, which have an inner radius suitable for the respective press fitting. The pressing tool must also be suitably matched to the respective press ring or press fitting. On the one hand, this matching must be geometrically correct, i.e. the closing distance of the pressing tool must be matched to the closing distance of the press ring. On the other hand, the pressing tool must be able to transmit the necessary closing force to be able to close the press ring on the press fitting. If, for example, a pressing tool that is geometrically too large is used, this can lead to incomplete closing of the press ring, so that insufficient pressing forces are applied to the press fitting, resulting in faulty pressing. Conversely, if a pressing tool that is geometrically too small is used, this can mean a pressing force beyond the closing point of the press ring, which in turn can lead to damage or even destruction of the press ring and press fitting.

If, for example, a pressing tool is used which provides too low a closing force, incomplete pressing may occur because the pressing tool switches off at its maximum pressing force before the press ring is completely closed.

If a pressing tool is used with too high a closing force, the press ring may be overloaded, which in turn may damage or even destroy the press ring and press fitting.

### SUMMARY OF THE INVENTION

It is the object of the present invention to provide a pressing tool, a press ring and a set of a pressing tool and a press ring in which damage and incomplete pressing can be prevented.

The object is achieved with a pressing tool as described herein, a press ring as described herein, a set as described herein and a system as described herein.

A first aspect of the present invention relates to a pressing tool for pressing a press fitting by means of a press ring. Here, the pressing tool has two pressing jaws which can be moved towards each other, in particular by a drive unit, from an open position to a closed position for pressing. Furthermore, the pressing jaws comprise a connecting element for connection to respective receiving elements of the press ring, so that the press ring can be moved by the movement of the pressing jaws from an open position to a closed position for pressing the press fitting.

According to the invention, the minimum distance between the connecting elements in the open position is greater than the maximum distance between the receiving elements of the press ring in the open position. Thus, the pressing tool according to the first aspect of the present invention is connectable to the press ring because the minimum spacing of the connecting elements is greater than the spacing of the receiving elements, respectively, in the open position. The pressing jaws of the pressing tool can thus be opened sufficiently wide to connect the pressing tool with the press ring.

Furthermore, the minimum distance of the connecting elements in the closed position just corresponds to the minimum distance of the receiving elements of the press ring also in the closed position. This ensures that the pressing tool according to the first aspect of the present invention can close the press ring and thus an optimal pressing of the press fitting can be achieved.

Furthermore, the minimum spacing of the connecting elements in the open position is smaller than the maximum spacing of the receiving elements of a second press ring in the open position, so that connection to the second press ring is prevented. Since the minimum spacing of the connecting elements in the open position in the pressing tool according to the first aspect of the present invention is smaller than the maximum spacing of the receiving elements of the second press ring, also in the open position, it is not possible, and therefore excluded, to connect the pressing tool according to the first aspect of the present invention to the second press ring. In other words, the pressing tool according to the first aspect of the present invention cannot be opened wide enough to be connected to the second, mismatched press ring. It is thereby that incorrect pressing or damage/destruction of the pressing tool or press fitting is prevented.

Preferably, the connecting element is formed by spherical segments or segments similar to spheres. In this case, the spherical segments can engage with correspondingly formed spherical recesses of the receiving elements. Spherical segments have the advantage that the press ring and the pressing tool can be connected at different angles to each other due to the rotational symmetry of the spherical segments. This provides improved manageability, since in particular the pressing tool can be used with the pressing device at an angle to the press ring.

Preferably, the connecting elements are designed as undercuts for connection to a connecting bolt of the press ring. In particular, if the press ring is designed as a press collar, the receiving elements can be designed as connecting bolts, which can be inserted into the undercuts of the connecting elements to connect the pressing tool with the press ring.

Preferably, the pressing tool can be connected to a pressing device, in particular an electro-hydraulic pressing device, for moving the pressing jaws. In this case, the connection can be permanent. Alternatively, the pressing tool is detachably connected to the pressing device.

A second aspect of the present invention relates to a pressing tool for pressing a press fitting by means of a press ring.

Here, the pressing tool has two pressing jaws which can be moved towards each other, in particular by a drive unit, from an open position to a closed position for pressing. Furthermore, the pressing jaws comprise a connecting element for connection to respective receiving elements of the press ring, so that the press ring can be moved by the movement of the pressing jaws from an open position to a closed position for pressing the press fitting. This may be the press ring according to the first aspect of the present invention, the second press ring as described above, or a press ring different therefrom.

According to the invention, the minimum distance between the connecting elements in the open position is greater than the maximum distance between the receiving elements of the press ring in the open position. Thus, the pressing tool according to the first aspect of the present invention is connectable to the press ring because the minimum spacing of the connecting elements is greater than the spacing of the receiving elements, respectively, in the open position. The pressing jaws of the pressing tool can thus be opened sufficiently wide to connect the pressing tool with the press ring.

Furthermore, the minimum distance of the connecting elements in the closed position just corresponds to the minimum distance of the receiving elements of the press ring also in the closed position. This ensures that the pressing tool according to the first aspect of the present invention can close the press ring and thus an optimal pressing of the press fitting can be achieved.

Furthermore, the minimum distance of the connecting elements in the closed position is greater than the minimum distance of the receiving elements of a third press ring in the open position, so that pressing with the third press ring is prevented. Thus, when the pressing jaws of the pressing tool according to the second aspect of the present invention are moved to the closed position, the connecting elements are spaced further apart than the minimum spacing of the receiving elements of the third press ring in the open position. Thus, there is just no movement of the press ring from the open position to the closed position, since there is no suitable transmission of the movement from the pressing tool to the third press ring. Thus, an unintended combination of the pressing tool according to the second aspect of the present invention with the third press ring is prevented. It is thereby that incorrect pressing/damage to the pressing tool or press ring as well as the press fitting is prevented.

Preferably, the minimum distance of the connecting elements in the open position is smaller than the maximum distance of the receiving elements of a fourth press ring in open position, so that a connection with the fourth press ring is prevented. The third press ring and the fourth press ring are different press rings.

Further, the pressing tool according to the second aspect of the present invention is further developed according to the features as described above with respect to the pressing tool according to the first aspect of the present invention.

A third aspect of the present invention relates to a press ring for pressing a press fitting by means of a pressing tool in particular according to the first aspect of the present invention. In this case, the press ring has at least two segments movably connected to one another, the segments being movable from an open position to a closed position by a movement of the pressing tool. Furthermore, the press ring has two receiving elements, each of which is connected to one of the segments or can be formed integrally with the same, for receiving a respective connecting element of the pressing tool.

According to the invention, the maximum distance between the receiving elements in the open position is smaller than a minimum distance between the connecting elements of the pressing tool in the open position. Thus, the pressing tool can be connected to the press ring, since the minimum distance between the connecting elements is greater than the distance between the receiving elements in the open position, respectively. The pressing jaws of the pressing tool can thus be opened sufficiently wide to connect the pressing tool with the press ring.

Furthermore, the minimum distance of the receiving elements in the closed position just corresponds to the minimum distance of the connecting elements of the pressing tool in the closed position. This ensures that the pressing tool can close the press ring and that, thus, optimum pressing of the press fitting can be achieved.

Furthermore, the maximum distance of the receiving elements in the open position is greater than the maximum distance of the connecting elements of a second pressing tool in the open position, so that a connection with the press ring is prevented. Since the maximum distance between the receiving elements in the open position of the press ring is greater than the maximum distance between the connecting elements of the second pressing tool in the open position, it is not possible, and therefore excluded, to connect the second pressing tool to the press ring. In other words, the pressing tool according to the first aspect of the present invention cannot be opened wide enough to be connected to the second, mismatched press ring. It is thereby that incorrect pressing or damage/destruction of the pressing tool or press fitting is prevented. In this regard, the second pressing tool may be the pressing tool according to the first aspect of the present invention, according to the second aspect of the present invention, or a pressing tool different therefrom.

Preferably, the receiving element is an undercut or a spherical recess into which a connecting element of the pressing tool designed as a spherical segment can be inserted.

Preferably, the receiving element is a connecting pin for connection to a connecting element of the pressing tool.

Preferably, the press ring is a press collar, which in particular has more than two segments.

Preferably, the press collar is designed as described in the utility model “Antriebseinheit” DE 20 2020 102 724.

A fourth aspect of the present invention relates to a press ring for pressing a press fitting by means of a pressing tool in particular according to the second aspect of the present invention. In this case, the press ring has at least two segments movably connected to one another, the segments being movable from an open position to a closed position by a movement of the pressing tool. Furthermore, the press ring has two receiving elements, each of which is connected to one of the segments or can be formed integrally with the same, for receiving a respective connecting element of the pressing tool.

According to the invention, the maximum distance between the receiving elements in the open position is smaller than a minimum distance between the connecting elements of the pressing tool in the open position. Thus, the pressing tool can be connected to the press ring, since the minimum distance between the connecting elements is greater than the distance between the receiving elements in the open position, respectively. The pressing jaws of the pressing tool can thus be opened sufficiently wide to connect the pressing tool with the press ring.

Furthermore, the minimum distance of the receiving elements in the closed position just corresponds to the minimum distance of the connecting elements of the pressing tool in the closed position. This ensures that the pressing tool can close the press ring and that, thus, optimum pressing of the press fitting can be achieved.

Furthermore, the maximum distance of the receiving elements in the open position is smaller than a minimum distance of the connecting elements of a third pressing tool in the closed position, so that pressing with the third pressing tool is prevented. Thus, if the pressing jaws of the third pressing tool are moved into the closed position, the connecting elements are spaced further apart than the minimum distance of the receiving elements of the press ring in the open position. Thus, there is just no movement of the press ring from the open position to the closed position, since there is no suitable transmission of the movement from the third pressing tool to the press ring. It is thereby that an unintentional combination of the third pressing tool with the press ring is thus prevented. It is thereby that incorrect pressing/damage to the pressing tool or press ring as well as the press fitting is prevented. Here, the third pressing tool may be the pressing tool according to the first aspect of the present invention, according to the second aspect of the present invention, or a pressing tool different therefrom.

Preferably, the maximum distance of the receiving elements in the open position is greater than a maximum distance of the connecting elements of a fourth pressing tool in the open position. Here, the third pressing tool and the fourth pressing tool are different pressing tools.

Further, the press ring according to the fourth aspect of the present invention is further developed according to the features as described above with respect to the press ring according to the third aspect of the present invention.

Furthermore, in a fifth aspect, the present invention relates to a set comprising a pressing tool according to the first aspect of the present invention and at least one press ring according to the third aspect of the present invention. In particular, the set comprises a first group of press rings, all of which can be matched and used with the pressing tool according to the first aspect of the present invention.

Furthermore, in a sixth aspect, the present invention relates to a set comprising a pressing tool according to the second aspect of the present invention and at least one press ring according to the fourth aspect of the present invention. In particular, the set comprises a second group of press rings, all of which can be matched and used with the pressing tool according to the first aspect of the present invention. In particular, the press rings of the first group according to the fifth aspect of the present invention cannot be used with the pressing tool of the present set.

Further, the present invention relates to a system comprising a set according to the fifth aspect of the present invention and a set according to the sixth aspect of the present invention.

Preferably, the system comprises a further set, wherein the further set comprises a pressing tool and a third group of press rings, wherein the press rings of the third group cannot be used with the pressing tools of the other sets, and wherein the press rings of the first group and/or the second group cannot be used with the pressing tool of the further set.

### BRIEF DESCRIPTION OF THE DRAWINGS

In the following, the invention is described in more detail by means of preferred embodiments with reference to the accompanying drawings.

The terms Fig., Figs., Figure, and Figures are used interchangeably in the specification to refer to the corresponding figures in the drawings.

In the Figures:

FIG. 1 shows a pressing device according to the present invention,

FIGS. 2A to 2C show a first set according to the present invention,

FIGS. 3A to 3C show a second set according to the present invention,

FIGS. 4A and 4B show another embodiment of the pressing tool.

### DESCRIPTION OF THE INVENTION

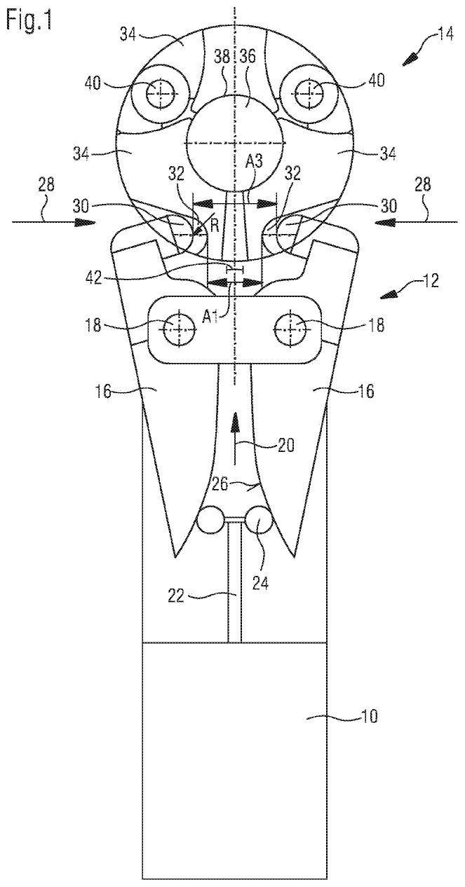

FIG. 1 shows a pressing tool according to the invention with a drive unit 10, which is designed, for example, as an electrohydraulic drive unit. Connected to the drive unit 10 is a pressing tool 12, which engages a press ring 14 for pressing a press fitting 38. Here, the drive unit 10 moves a cylinder 22 according to the arrow 20. In the process, the rollers 24 come into contact with the curved contact surfaces 26. The movement of the cylinder 22 then causes the pressing jaws 16 of the pressing tool 12 to pivot about the axes of rotation 18. This moves the connecting elements 30 opposite the contact surfaces 26 towards each other from an open position to a closed position in accordance with the arrows 28.

In the example of FIG. 1, the connecting elements 30 are formed as ball segments. These engage in receiving elements 32, which are formed in correspondingly shaped spherical recesses of the press ring 14. The press ring 14 has several segments 34, which are rotatably connected to each other about the axes of rotation 40. By moving the pressing jaws 16 of the pressing tool 12, the press ring 14 is transferred from an open position shown in FIG. 1 to a closed position. Here, the distance 42 between the terminal segments 34 is reduced. This reduces the radius of the inner opening 36, which is formed by the segments 34, so that a pressing force is transmitted to the press fitting 38 and the latter is pressed.

In the following, identical or similar components are identified by identical reference numerals.

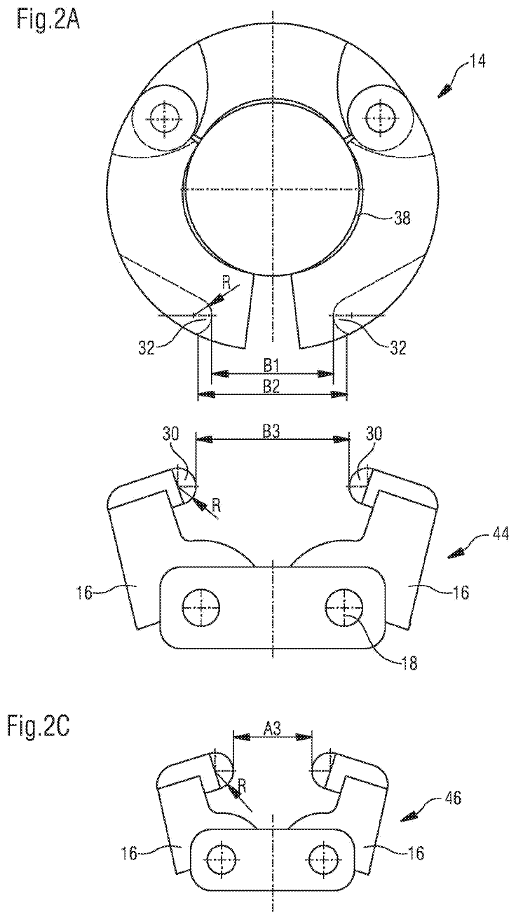

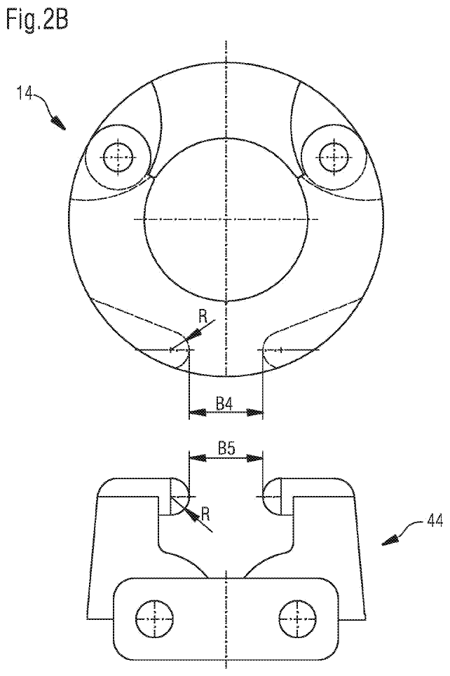

FIG. 2 shows a first set consisting of a first pressing tool 44 and a first press ring 14, which are designed to match each other.

In FIG. 2A, both the first press ring 14 and the first pressing tool 44 are shown in an open position. In this context, an open position is a position in which the pressing device has not yet been moved or the press ring 14 is set around the press fitting 38 in a force-free manner. The open position is characterized by an open press ring 14 with a corresponding distance 42 (shown in FIG. 1) of the terminal segments 42. In the case of the first pressing tool 44, the minimum distance between the connecting elements 30 is marked by B3. Furthermore, the minimum distance of the receiving elements 32 of the first press ring 14 is marked by B1, whereas the maximum distance of the receiving elements 32 is marked by B2. Here, the minimum distance B1 is measured, for example, from the bottom of the spherical recess of the receiving element 32. On the other hand, the maximum distance B2 of the receiving elements 32 in the example shown in FIG. 2 denotes the minimum distance B2 that the connecting elements 30 must have in order to fit over the projection of the receiving elements 32. Thus, for the set of FIG. 2, B3>B2 applies to the open position of both the first press ring 14 and the first pressing tool 44 as shown in FIG. 2A.

FIG. 2B shows the first set in the closed position, i.e. after pressing has been performed. In this case, the minimum distance B4 of the receiving elements 32 of the first press collar 14 is reduced from B1 to B4. In particular, the distance 41 of the terminal segments 34 of the first press collar 14 is reduced to 0 or almost 0. At the same time, the minimum distance of the connecting elements 30 of the first pressing tool 44 has been reduced from B3 to B5. In this case, the closed position of the first pressing tool 44, shown in FIG. 2B, corresponds to the maximum closing of the first pressing tool at the end of the stroke of the cylinder 22. In particular, further closing or reduction of the minimum distance B5 of the connecting elements 30 is not possible. Here, B4 is selected equal to B5. The minimum distance B5 of the connecting elements 30 at the end of the travel path just corresponds to a completely closed press ring 14 or a minimum distance B4 of the receiving elements 32 of the first press ring 14, so that a complete and proper pressing of the press fitting 38 is ensured.

If an attempt is made to operate the first press ring 14 with a second pressing tool 46, which is not suitable, this is not possible, since in particular the minimum distance A3 of the second pressing tool 46 of the connecting elements 30 in the open position shown in FIG. 2C is smaller than the maximum distance B2 of the receiving elements 32 of the first press ring 14. It is therefore not possible to push the connecting elements 30 over the projection of the receiving elements 32 of the first press ring 14. Thus, it is not possible to apply the second pressing tool 46 to the first press ring 14. This prevents incorrect pressing and/or damage to the pressing tool or press ring.

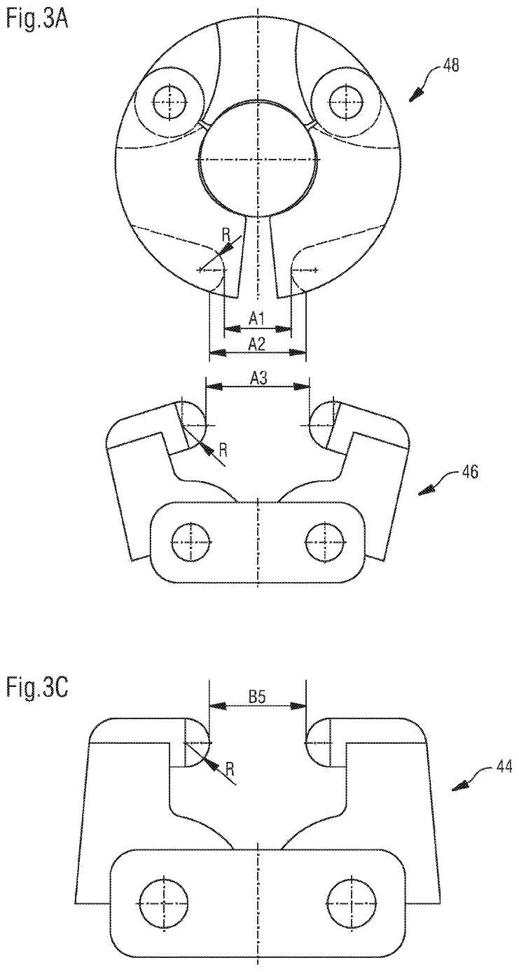

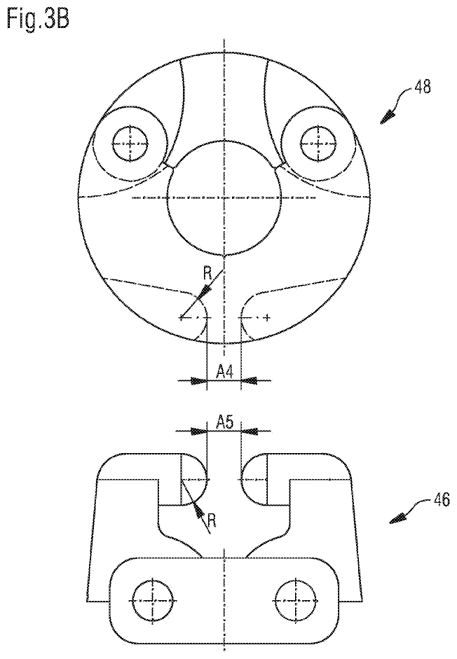

FIG. 3 shows a second set including a second pressing tool 46 and a second press ring 48. Here, the second pressing tool 46 may be the same as or different from the pressing tool of FIG. 2C. In any case, a minimum distance A1 of the receiving elements 32 of the second press ring 48, the maximum distance A2 of the receiving elements 32 of the second press ring 48 and the minimum distance A3 of the connecting elements 30 of the second pressing tool 46 are also matched to each other in such a way that A3>A2 is selected and thus the connecting elements 30 of the second pressing tool 46 can fit over the projections of the receiving elements 32 of the second press collar 48 and thus the connecting elements 30 can be inserted into the recesses of the receiving elements 32. Here, FIG. 3A shows the second set in an open position of the second press collar 48 and the second pressing tool 46, respectively. FIG. 3B shows both the press collar 48 and the second pressing tool 46 in a closed position. Here, the minimum distance A5 of the connecting elements 30 of the second pressing tool 46 corresponds to the minimum distance A4 of the receiving elements 32 of the second press ring 48. Based on this correspondence, a complete pressing of the press fitting can take place.

If an attempt is now made to operate the second press ring 48 with another pressing tool 44, this is just not possible due to the selected dimensions. In particular, the further pressing tool 44 can correspond to the first pressing tool 44 of FIG. 2 or be different therefrom. Here, the minimum distance B5 of the connecting elements 30 of the second pressing tool 44 corresponds to the minimum distance A1 of the receiving elements 32 of the second press ring 48. Thus, if the further pressing tool 44 is completely closed or at the end of the travel path, no pressing of the press fitting 38 has taken place with the second press collar 48. This is clearly recognizable by the user. In particular, no incomplete or incorrect pressing follows.

In particular, several press rings can be combined into a group, which can all be pressed with the same pressing tool. Here, the dimensions are suitably adapted according to the sets of FIGS. 2 and/or 3. Further press collars can be combined into a second group or further groups, wherein a special pressing tool is provided for each group and all press rings of a group can be properly pressed with the same pressing tool. However, the pressing tools of one group cannot be used with the press rings of the other group, since the minimum distance in the open position of the pressing tool is smaller than the maximum distance of the receiving elements of the press rings of the other group in the open position. Alternatively, the minimum distance of the connecting elements of the pressing tool in the closed position is greater than the minimum distance of the receiving elements of the press rings of the other group. Alternatively, the minimum distance in the open position of the pressing tool is smaller than the maximum distance of the receiving elements of the press rings of the first other group in the open position, and furthermore the minimum distance of the connecting elements of the pressing tool in the closed position is larger than the minimum distance of the receiving elements of the press rings of the second other group. Thus, three or more groups can be formed with a corresponding number of different pressing tools and one or more press collars per group.

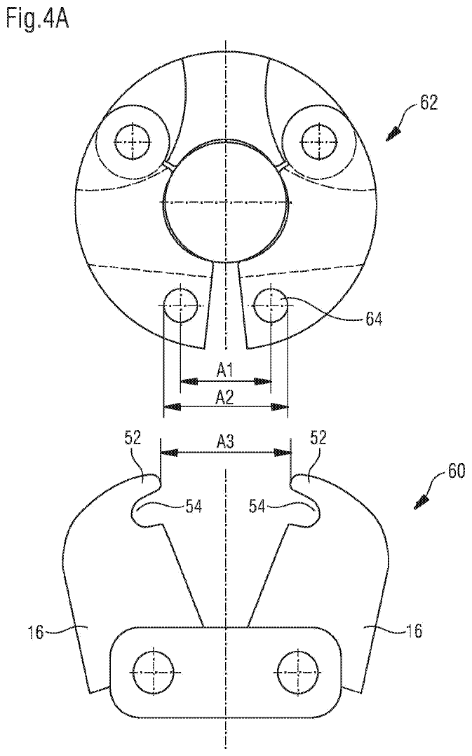

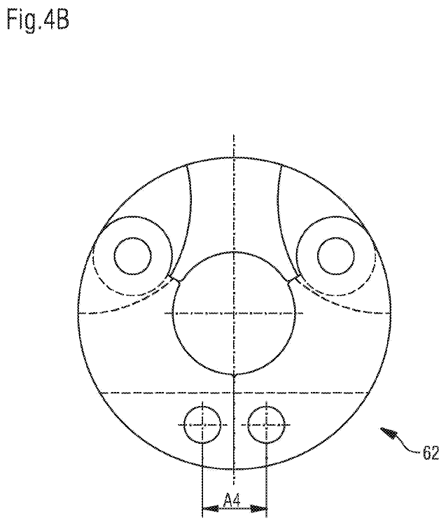

FIGS. 4A and 4B show a further embodiment of the connecting element, wherein the connecting element 52 of the pressing tool 50 according to FIG. 4A is formed as an undercut 54, for example for connection to a connecting pin 64 of a press collar 62 as described, for example, in the utility model “Antriebseinheit” DE 20 2020 102 724. Here, the minimum distance A3 is the distance between the ends of the lugs 52 delimiting the recess 44, which are directed towards each other. At the same time, the maximum distance is the distance between the bottom surfaces of the respective recesses 54. FIG. 4A shows the press collar 62 in an open position, wherein the connecting bolts 64 have a maximum distance A2 which is smaller than the minimum distance A3 of the matching pressing tool 50. FIG. 4B shows the press collar in a closed position with a minimum distance A4 which substantially corresponds to the distance of the connecting elements 52 of the matching pressing tool 50.

In other words:

1. Press ring type A can be operated with a type A tool. The type A tool only presses in combination with type A press rings. The opening of the type A tool is too small to be placed on type B and type C press rings.

2. Press ring type B can be operated with a type B tool. The type B tool only presses in combination with type B press rings. The opening of the type B tool is too small to be placed on type C press rings. At the same time, the opening of the type B tool is too large to be able to press type A press rings.

3. Press ring type C can be operated with a type C tool. The type C tool only presses in combination with type C press rings. The opening of the type C tool is too large to be able to press type A and type B press rings.

Thus a system is created by which an unintentional combination of a press ring and a pressing tool is avoided. In particular, the geometric dimensions of the connecting elements and the receiving elements prevent a combination of a pressing tool and a press ring which are not suitable. Incomplete pressing, damage to the pressing tool or the press ring due to an unsuitable combination of a pressing tool and a press ring are thus prevented.

What is claimed is:

1. A system comprising:
at least one pressing tool comprising a first pressing tool, wherein each of the at least one pressing tool individually comprises:
two pressing jaws configured to be moved towards each other from an open position to a closed position for pressing a press fitting; and
a set of two connecting elements, each of the set of two connecting elements connected to one of the two pressing jaws; and
at least two press rings comprising a first press ring and a second press ring, wherein each of the at least two press rings individually comprise:
at least two segments movably connected to each other, the at least two segments being movable from an open position to a closed position; and
a set of two receiving elements, each receiving element of the set of two receiving elements being connected to one of the at least two segments,
wherein the set of two receiving elements of the first press ring is configured to receive one of a respective set of two connecting elements from only the first pressing tool, and the set of two receiving elements of the second press ring is configured to not receive one of a respective set of two connecting elements from the first pressing tool, and
wherein the first pressing tool is designed to only operatively engage and press with the first press ring, such that the first pressing tool will not operatively engage and press with the second press ring.

2. The system of claim 1, wherein the set of two connecting elements of the first pressing tool permit the first pressing tool to operatively engage the set of two receiving elements of the first press ring so as to enable the first press ring to be moved from an open position to a closed position by movement of the two pressing jaws of the first pressing tool.

3. The system of claim 2, wherein (i) a minimum distance of the set of two connecting elements of the first pressing tool, when the two pressing jaws of the first pressing tool are in the open position, is greater than (ii) a maximum distance of the set of two receiving elements of the first press ring, when the at least two segments of the first press ring are in the open position.

4. The system of claim 3, wherein (i) the minimum distance of the set of two connecting elements of the first pressing tool, when the two pressing jaws of the first pressing tool are in the closed position, corresponds to (ii) a minimum distance of the set of two receiving elements of the first press ring, when the at least two segments of the first press ring are in the closed position.

5. The system of claim 4, wherein (i) a first distance comprising the minimum distance of the set of two connecting elements of the first pressing tool, when the two pressing jaws of the first pressing tool are in the open position, is smaller than (ii) a second distance comprising a maximum distance of the set of two receiving elements of the second press ring, when the at least two segments of the second press ring are in an open position, such that a physical difference between the first distance and the second distance prevents the first pressing tool and the second press ring from engaging together to form a connection between the first pressing tool and the second press ring.

6. The system of claim 1, wherein the set of two connecting elements of each of the at least one pressing tool comprises spherical segments.

7. The system of claim 1, wherein the first press ring comprises first connecting bolts, the set of two connecting elements of the first pressing tool comprises undercuts for connection to the first connecting bolts of the first press ring, and the second press ring comprises second connecting bolts.

8. The system of claim 1, wherein each of the at least one pressing tool can be individually connected to a pressing device for moving the two pressing jaws of the respective pressing tool.

9. The system of claim 1, wherein each receiving element of the set of two receiving elements of the first press ring and the second press ring is an undercut.

10. The system of claim 1, wherein each receiving element of the set of two receiving elements of the first press ring and the second press ring is a connecting bolt.

11. The system of claim 1, wherein the first press ring and the second press ring each comprise a press collar that has more than two segments.

12. The system of claim 1, wherein the at least one pressing tool further comprises a second pressing tool, and wherein the second pressing tool is designed to only operatively engage and press with the second press ring, such that the second pressing tool will not operatively engage and press with the first press ring.

13. The system of claim 12, wherein the at least two press rings further comprise a third press ring, wherein the at least one pressing tool further comprises a third pressing tool, wherein the first pressing tool is designed to only operatively engage and press with the first press ring, such that the first pressing tool will not operatively engage and press with the second press ring and will not operatively engage and press with the third press ring, wherein the second pressing tool is designed to only operatively engage and press with the second press ring, such that the second pressing tool will not operatively engage and press with the first press ring and will not operatively engage and press with the third press ring, and wherein the third pressing tool is designed to only operatively engage and press with the third press ring, such that the third pressing tool with not operatively engage and press with the first press ring and will not operatively engage and press with the second press ring.

14. The system of claim 13, wherein the set of two connecting elements of the first pressing tool permit the first pressing tool to operatively engage the set of two receiving elements of the first press ring so as to enable the first press ring to be moved from an open position to a closed position by movement of the two pressing jaws of the first pressing tool, wherein (i) a minimum distance of the set of two connecting elements of the first pressing tool, when the two pressing jaws of the first pressing tool are in the open position, is greater than (ii) a maximum distance of the set of two receiving elements of the first press ring, when the at least two segments of the first press ring are in the open position, and wherein (i) the minimum distance of the set of two connecting elements of the first pressing tool, when the two pressing jaws of the first pressing tool are in the closed position, corresponds to (ii) a minimum distance of the set of two receiving elements of the first press ring, when the at least two segments of the first press ring are in the closed position.

15. The system of claim 14, wherein (i) a first distance comprising the minimum distance of the set of two connecting elements of the first pressing tool, when the two pressing jaws of the first pressing tool are in the open position, is smaller than (ii) a second distance comprising a maximum distance of a set of two receiving elements of the second press ring, when the at least two segments of the second press ring are in the open position, such that a physical difference between the first distance and the second distance prevents the first pressing tool and the second press ring from engaging together to form a connection between the first pressing tool and the second press ring.

16. The system of claim 15, wherein (i) the first distance the minimum distance of the set of two connecting elements of the first pressing tool, when the two pressing jaws of the first pressing tool are in the open position, is smaller than (ii) a third distance comprising a maximum distance of the set of two receiving elements of the third press ring, when the at least two segments of the third press ring are in the open position, such that a physical difference between the first distance and the third distance prevents the first pressing tool and the third press ring from engaging together to form a connection between the first pressing tool and the third press ring.

17. A system comprising:
at least two pressing tools comprising a first pressing tool and a second pressing tool, wherein each of the at least two pressing tools individually comprises:
two pressing jaws configured to be moved towards each other from an open position to a closed position for pressing a press fitting; and
a set of two connecting elements, each of the set of two connecting elements connected to one of the two pressing jaws; and
at least one press ring comprising a first press ring, wherein each of the at least one press ring individually comprises:
at least two segments movably connected to each other, the at least two segments being movable from an open position to a closed position; and
a set of two receiving elements, each receiving element of the set of two receiving elements being connected to one of the at least two segments, and the set of two receiving elements being configured to receive the set of two connecting elements from only the first pressing tool and not the second pressing tool,
wherein the first pressing tool is designed to only operatively engage and press with the first press ring; and
wherein the second pressing tool is designed to not operatively engage and press with the first press ring.

18. A method of pressing a press fitting, the method comprising using the system of claim 1 to accomplish the steps of:
engaging the first press ring with a first press fitting;
engaging the first pressing tool with the first press ring to form a first pressing combination; and
pressing the first pressing combination so as to result in a first pressed fitting.

19. A method of pressing a press fitting, the method comprising using the system of claim 12 to accomplish the steps of:
engaging at least one of (i) the first press ring with a first press fitting, or (ii) the second press ring with a second press fitting;
engaging at least one of (i) the first pressing tool with the first press ring to form a first pressing combination, or (ii) the second pressing tool with the second press ring to form a second pressing combination; and
pressing at least one of the first pressing combination or the second pressing combination so as to result in at least one of a first pressed fitting or a second pressed fitting.

20. A method of pressing a press fitting, the method comprising using the system of claim 13 to accomplish the steps of:
engaging at least one of (i) the first press ring with a first press fitting, (ii) a second press ring with a second press fitting, or (iii) a third press ring with a third press fitting;
engaging at least one of (i) the first pressing tool with the first press ring to form a first pressing combination, (ii) the second pressing tool with the second press ring to form a second pressing combination, or (iii) the third pressing tool with the third press ring to form a third pressing combination; and
pressing at least of the first pressing combination, the second pressing combination, or the third pressing combination so as to result in at least one of a first pressed fitting, a second pressed fitting, or a third pressed fitting.
